(19) United States
(12) Patent Application Publication
(10) Pub. No.: US 2012/0124025 A1
(43) Pub. Date: May 17, 2012

(54) Method for Querying a Search Word Via SMS and Sending a Search Engine Results to Mobile Devices

(75) Inventors: Ozan Saglam, Istanbul (TR); Ozlem Sancar, Istanbul (TR)

(73) Assignee: TURKCELL ILETISIM HIZMETLERI ANONIM SIRKETI, Istanbul (TR)

(21) Appl. No.: 13/257,586

(22) PCT Filed: Jan. 25, 2010
(86) PCT No.: PCT/IB10/50302

§ 371 Date: Nov. 30, 2011

(30) Foreign Application Priority Data
Mar. 18, 2009 (TR) 2009/02124

(51) Int. Cl. G06F 17/30

(52) U.S. Cl. 707/707; 707/E17.108

(57) ABSTRACT

The present invention relates to a method for sending the content about which information is desired to be obtained to a number as a short message (SMS) and sending the web address (URL) of the result page of a certain search engine defined on the system to the user via WAPpush or short message.

### FIELD OF THE INVENTION

The present invention relates to a method for sending the keywords related to the content about which information is desired to be obtained to a number as a short message (SMS), and sending the web address (URL) of the result page of a certain search engine defined on the system to the users via WAPpush or SMS.

### PRIOR ART

In the state of the art, users search the word that they want to search on the search engine pages by accessing internet via WAP (wireless application protocol) with their mobile device. Users go to the page of the search engine using their cell phones, wait for page to open, enter the word desired to be searched into the text entry form and wait for the result page.

In U.S. Pat. No. 7,020,685, in the state of the art, a system that enables wireless communication devices which do not connect to internet or any other network to obtain the information on the Internet via SMS (short message service).

In US 2007/0027857, in the state of the art, it is disclosed that the results of search made through mobile or computer (PC) client are sent as SMS, WAPpush, MMS (Multimedia Messaging Service).

### SUMMARY OF THE INVENTION

The objective of the present invention is to realize a method sending the keywords related to the content about which information is desired to be obtained to a number as a short message (SMS), and sending the web address (URL) of the result page of a certain search engine defined on the system to the users via WAPpush or SMS.

### DETAILED DESCRIPTION OF THE INVENTION

A method for querying a search word via SMS and sending search engine results to mobile devices method realized to fulfill the objective of the present invention is illustrated in the accompanying figures wherein:

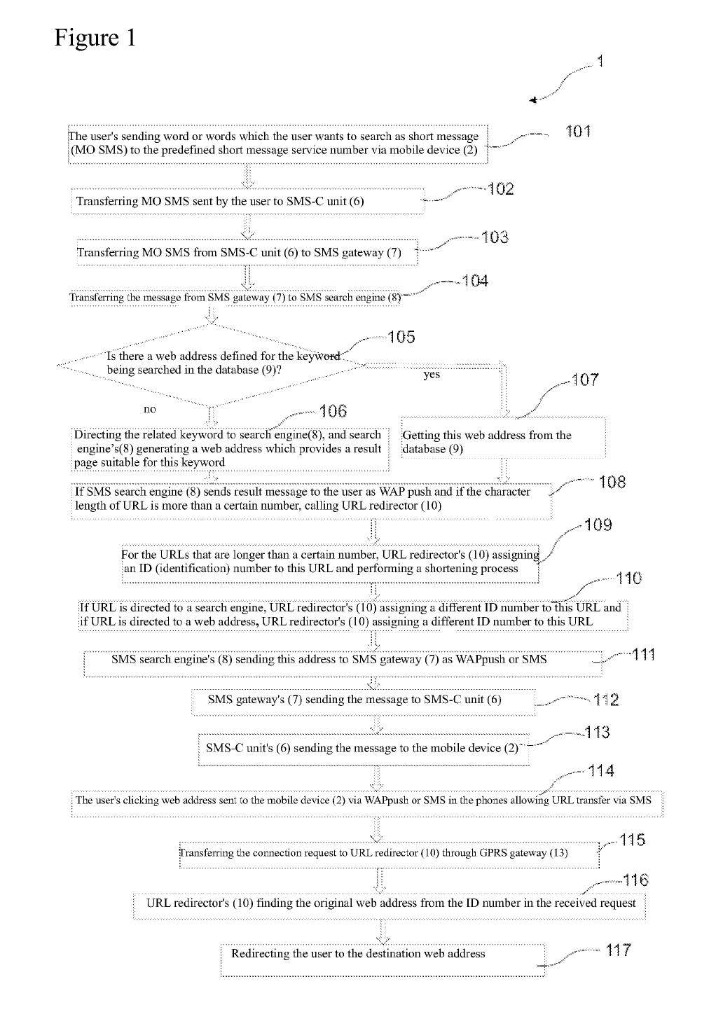

FIG. 1 is the flow chart of the method according to the invention.

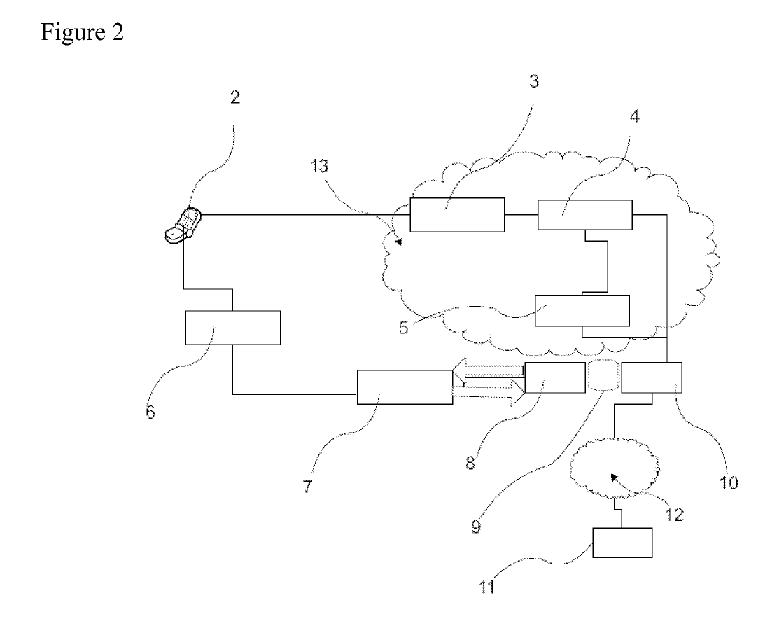

FIG. 2 is the block diagram of the system in which the method according to the invention is applied.

The components in the figures are numbered individually, where the numbers refer to the following:
1. Method
2. Mobile device
3. SGSN (Serving GPRS Support Node) unit
4. GGSN (Gateway GPRS Support Node) unit
5. WAP gateway (Wireless application protocol gateway)
6. SMS-C (Short Message Service-Center) unit
7. SMS gateway
8. SMS search engine
9. Database
10. URL Redirector
11. Destination web site
12. IP (Internet Protocol) network
13. GPRS network

System in which the inventive method (1) is applied uses at least one GPRS network (13) having at least one SGSN unit (3), at least one GGSN unit (4) and at least one WAP gateway (5), and comprises at least one mobile device (2), at least one SMS-C unit (6), at least one SMS gateway (7), at least one SMS search engine (8) and at least one database (9).

SGSN unit (3) is responsible for transmitting the network packets to mobile device (2) on the GPRS network (13). It has the functions of packet redirection, transfer, mobility management, authorization and charging.

GGSN unit (4) provides connection between GPRS network (13) and IP network (12). It has authorization and charging functions.

WAP gateway (5) functions as Proxy in the connections made from WAP APN (Access Point Name) for the mobile devices (2).

SGSN unit (3), GGSN unit (4) and WAP gateway (5) nodes are the nodes belonging to GPRS network (13).

SMS-C unit (6) provides to send SMS to mobile devices (2), and to send the SMSs sent by the mobile devices (2) to other users (peer to peer) or to the short codes defined on the system. This unit (6) can send binary messages such as WAPpush in addition to SMS.

SMS gateway (7) is located in front of the SMS-C units (6). SMS gateway (7) provides authorization for the applications connected to itself and sends the messages to SMS-C units (6) and thus to the mobile phones (2) of the users (MT-Mobile-terminated SMS). Moreover, it transfers the SMSs sent by the users to the related interfaces.

Considering the keywords in content in the SMS (MO—Mobile-originated SMS) sent by the user, SMS Search Engine (8) either generates a web address (URL—Uniform Resource Locator) and sends this address to the user, or if there is a web address assigned to the keyword searched by the user, then sends directly the web address to the user.

Database (9) provides information sharing between SMS search engine (8) and URL redirector (10). Configuration information and logs related to SMS search engine are stored in the database (9). In the database (9), web addresses corresponding to certain keywords are defined.

Destination web site (11) is defined as the destination web site that will be visited by the user or search engine web site.

In the method (1), the user sends the keyword which the user wants to search as a message to a short codes defined by the operator. SMS sent to this short code is transferred to SMS gateway (7) through SMS-C unit (6). It is decided that the messages sent to the defined number in the SMS gateway (7) should be sent to SMS search engine (8) according to the redirection table in the SMS gateway. SMSs sent to the number defined by the operator are transferred to SMS search engine (8). The keyword included in the received SMS is examined, and the database (9) is checked whether a web address has been defined for this keyword. If there is an URL defined for this keyword, this URL is chosen or, if not, another URL is generated by the search engine (8). After URL generation is completed, SMS search engine (8) sends this URL to the mobile phone (2) of the user as WAPpush or SMS.

According to an embodiment of the invention, search result is sent to the user as WAPpush. In this embodiment, the system comprises an URL redirector (10). URL redirector (10) directs page requests coming from HTTP (Hypertext Transfer Protocol) protocol to a new web address page. URL redirector (10) can give service to the access maintained through more than one Access Points (Access Point Name-APN) such as WAP access point, internet access point in the GPRS connection.

URL having a certain character length can be sent as WAPpush message. Messages including URL that is longer than a certain character length are rejected. Therefore, SMS search engine (8) generates a new URL by means of URL redirector (10) in order to shorten URL. The original URL transferred to URL redirector (10) is stored, and an ID number is assigned to this URL. URL to be sent to cell phone (2) of the user is sent with said ID number. Thus, URLs are arranged so as to be suitable for WAPpush procedure.

WAPpush messages are sent as binary SMS to mobile devices. Depending on the length of URL and indicator information, the messages to be sent is sent, if necessary, as a more than one messages such that the messages are combined by the mobile device (2) and considered as a single SMS (as concat message).

When the user clicks on the WAPpush sent to mobile device (2), the mobile device (2) accesses URL redirector (10) passing through SGSN and GGSN units (3, 4) on the GPRS network (13). URL redirector (10) checks the ID number of URL which has been received and directs the mobile device (2) to this URL.

Thereby, URL defined for the keyword or search engine result page is displayed on the mobile device (2).

The method (1) comprises the following steps:
the user's sending word or words which the user wants to search as short message (MO SMS) to the predefined short message service number via mobile device (2) (101),
transferring MO SMS sent by the user to SMS-C unit (6) (102),
transferring MO SMS from SMS-C unit (6) to SMS gateway (7) (103),
transferring the message from SMS gateway (7) to SMS search engine (8) (104),
SMS search engine's (8) receiving the content in MO SMS and comparing the word or words/phase desired to be searched with the table in the database (9), and checking whether there is a web address defined for the keyword being searched in the database (9) (105),
if there is not a web address defined in the database (9) for this keyword, redirecting the related keyword to search engine (8), and search engine's (8) generating a web address which provides a result page suitable for this keyword (106),
if there is a web address defined for this keyword in the database (9), getting this web address from the database (9) (107),
if SMS search engine (8) sends result message to the user as WAPpush and if the character length of URL is more than a certain number, calling URL redirector (10) (108)
for the URLs that are longer than a certain number, URL redirector's (10) assigning an ID (identification) number to this URL and performing a shortening process (109),
if URL is directed to a search engine, URL redirector's (10) assigning a different ID number to this URL and if URL is directed to a web address, URL redirector's (10) assigning a different ID number to this URL (110),
SMS search engine's (8) sending this address to SMS gateway (7) as WAPpush or SMS (111),
SMS gateway's (7) sending the message to SMS-C unit (6) (112),
SMS-C unit's (6) sending the message to the mobile device (2) (113),
the user's clicking web address sent to the mobile device (2) via WAPpush or SMS in the phones allowing URL transfer via SMS (114),
transferring the connection request to URL redirector (10) through GPRS gateway (13) (115),
URL redirector's (10) finding the original web address from the ID number in the received request (116),
Redirecting the user to the destination web address (117).

It is possible to develop a wide variety of embodiments of the inventive method. The invention cannot be limited to the examples described herein and it is essentially according to the claims.

1.-3. (canceled)

4. An URL transfer method wherein a plurality of keyword queries made by a user via a short message sent through a mobile device is transferred to a search engine by means of at least one SMS-C unit and at least one SMS gateway, the method comprising:
checking whether there is an URL assigned to a keyword queried in a database via the SMS search engine and,
if so, sending the assigned URL to the user and,
if not, sending a newly generated URL to the user via WAPpush or SMS.

5. The URL transfer method according to claim 4, wherein a plurality of URLs are arranged so as to become suitable for the WAPpush procedure by means of an URL redirector.

6. The URL transfer method according to claim 4, further comprising the following steps:
the user sending one or more keywords to be searched as a short message (MO SMS) to a predefined short message service number via the mobile device (101);
transferring the MO SMS sent by the user to the SMS-C unit (102);
transferring the message from the SMS-C unit to the SMS gateway (103);
transferring the MO SMS from the SMS gateway to the SMS search engine (104);
the SMS search engine receiving content in the MO SMS and comparing the one or more keywords desired to be searched with a table in the database, and checking whether there is a web address defined for the keyword being searched in the database (105);
if there is no web address defined in the database for this keyword, redirecting a related keyword to the search engine, and the search engine generating a web address which provides a result page suitable for this keyword (106);
if there is a web address defined for this keyword in the database, obtaining the defined web address from the database (107);
if the SMS search engine sends a result message to the user as a WAPpush and if a character length of an URL of the web address is more than a predefined number, calling an URL redirector (108);
for an URL that is longer than a predefined number, the URL redirector assigning an identification (ID) number to the URL and performing a shortening process (109);
if the URL is directed to a search engine, the URL redirector assigning a different ID number to the URL and if the URL is directed to a web address, the URL redirector assigning a different ID number to the URL (110);
the SMS search engine sending this web address to the SMS gateway as a WAPpush or an SMS (111);
the SMS gateway sending the message to the SMS-C unit (112);
the SMS-C unit sending the message to the mobile device (113);
the user clicking a web address sent to the mobile device via the WAPpush or the SMS in the mobile device allowing URL transfer via SMS (114);
transferring a connection request to the URL redirector through a GPRS gateway (115);
the URL redirector finding an original web address from the ID number in the received request (116);
redirecting the user to the destination web address (117).

7. The URL transfer method according to claim 5, further comprising the following steps:
the user sending one or more keywords to be searched as a short message (MO SMS) to a predefined short message service number via the mobile device (101);
transferring the MO SMS sent by the user to the SMS-C unit (102);
transferring the message from the SMS-C unit to the SMS gateway (103);
transferring the MO SMS from the SMS gateway to the SMS search engine (104);
the SMS search engine receiving content in the MO SMS and comparing the one or more keywords desired to be searched with a table in the database, and checking whether there is a web address defined for the keyword being searched in the database (105);
if there is no web address defined in the database for this keyword, redirecting a related keyword to the search engine, and the search engine generating a web address which provides a result page suitable for this keyword (106);
if there is a web address defined for this keyword in the database, obtaining the defined web address from the database (107);
if the SMS search engine sends a result message to the user as a WAPpush and if a character length of an URL of the web address is more than a predefined number, calling the URL redirector (108);
for an URL that is longer than a predefined number, the URL redirector assigning an identification (ID) number to the URL and performing a shortening process (109);
if the URL is directed to a search engine, the URL redirector assigning a different ID number to the URL and if the URL is directed to a web address, the URL redirector assigning a different ID number to the URL (110);
the SMS search engine sending this web address to the SMS gateway as a WAPpush or an SMS (111);
the SMS gateway sending the message to the SMS-C unit (112);
the SMS-C unit sending the message to the mobile device (113);
the user clicking a web address sent to the mobile device via the WAPpush or the SMS in the mobile device allowing URL transfer via SMS (114);
transferring a connection request to the URL redirector through a GPRS gateway (115);
the URL redirector finding an original web address from the ID number in the received request (116);
redirecting the user to the destination web address (117).
